(19) United States
(12) Patent Application Publication
(10) Pub. No.: US 2015/0098052 A1
(43) Pub. Date: Apr. 9, 2015

(54) LIQUID CRYSTAL DISPLAY DEVICE

(71) Applicant: Japan Display Inc., Minato-ku (JP)

(72) Inventors: Yusuke MORITA, Minato-ku (JP); Jin HIROSAWA, Minato-ku (JP)

(73) Assignee: Japan Display Inc., Minato-ku (JP)

(21) Appl. No.: 14/504,532

(22) Filed: Oct. 2, 2014

(30) Foreign Application Priority Data
Oct. 3, 2013 (JP) 2013-208180

(51) Int. Cl. G02F 1/1343; G02F 1/1335; G02F 1/1368; G02F 1/1362

(52) U.S. Cl. CPC G02F 1/134363; G02F 1/136286; G02F 1/133528; G02F 1/1368; G02F 1/13439; G02F 1/136213; G02F 2001/133531
USPC 349/139

(57) ABSTRACT

A liquid crystal display device includes a first substrate and a second substrate. The first substrate includes a pixel electrode having a contact portion and a main pixel electrode extending in a second direction from the contact portion so as to form one end opposite to the contact portion. The second substrate includes a pair of main common electrodes arranged on both sides sandwiching the main pixel electrode and extending in the second direction. The width of the contact portion in a first direction orthogonally crossing the second direction is larger than the width of the main pixel electrode in the first direction. The main common electrode includes a convex portion provided in a position more apart from the contact portion than the one end of the main pixel electrode and protruding in the first direction.

### CROSS-REFERENCE TO RELATED APPLICATION

This application is based upon and claims the benefit of priority from prior Japanese Patent Application No. 2013-208180 filed Oct. 3, 2013, the entire contents of which are incorporated herein by reference.

### FIELD

Embodiments described herein relate generally to a liquid crystal display device.

### BACKGROUND

In recent years, a flat panel display device is developed briskly, and especially the liquid crystal display device gets a lot of attention from advantages, such as light weight, thin shape, and low power consumption. Especially, in an active matrix type liquid crystal display device equipped with a switching element in each pixel, a structure using lateral electric field, such as IPS (In-Plane Switching) mode and FFS (Fringe Field Switching) mode, attracts attention. The liquid crystal display device using the lateral electric field mode is equipped with pixel electrodes and common electrodes formed in an array substrate, respectively. Liquid crystal molecules are switched by the lateral electric field substantially in parallel with the principal surface of the array substrate.

On the other hand, another technique is also proposed, in which the liquid crystal molecules are switched using the lateral electric field or an oblique electric field between the pixel electrode formed in the array substrate and the common electrode formed in a counter substrate.

### BRIEF DESCRIPTION OF THE DRAWINGS

The accompanying drawings, which are incorporated in and constitute a portion of the specification, illustrate embodiments of the invention, and together with the general description given above and the detailed description of the embodiments given below, serve to explain the principles of the invention.

FIG. 1 is a figure schematically showing a structure and an equivalent circuit of a liquid crystal display device according to one embodiment.

FIG. 2A is a plan view schematically showing a structure of one pixel PX when the liquid crystal display panel shown in FIG. 1 is seen from a counter substrate side according to a first embodiment.

FIGS. 2B and 2C are figures showing polarizing axes, respectively.

FIG. 3 is a cross-sectional view schematically showing the structure of the liquid crystal display panel taken along line A-A shown in FIG. 2A.

FIG. 4 is a plan view schematically showing a structure of one pixel when the liquid crystal display panel shown in FIG. 1 is seen from the counter substrate side according to a second embodiment.

FIG. 5 is a plan view schematically showing a structure of one pixel when the liquid crystal display panel shown in FIG. 1 is seen from the counter substrate side according to a third embodiment.

FIG. 6 is a plan view schematically showing a structure of one pixel when the liquid crystal display panel shown in FIG. 1 is seen from the counter substrate side according to a fourth embodiment.

FIG. 7 is a plan view schematically showing a structure of one pixel in which widths of both a main pixel electrode and a common electrode in a first direction are uniform according to a reference example.

### DETAILED DESCRIPTION

A liquid crystal display device according to an exemplary embodiment of the present invention will now be described with reference to the accompanying drawings wherein the same or like reference numerals designate the same or corresponding portions throughout the several views.

According to one embodiment, a liquid crystal display device comprises: a first substrate including a pixel electrode including a contact portion and a main pixel electrode extending in a second direction from the contact portion so as to form one end opposite to the contact portion; a second substrate including a pair of main common electrodes arranged on both sides sandwiching the main pixel electrode and extending in the second direction; and a liquid crystal layer held between the first substrate and the second substrate, wherein the width of the contact portion in a first direction orthogonally crossing the second direction is larger than the width of the main pixel electrode in the first direction, and the main common electrode includes a convex portion provided in a position more apart from the contact portion than the one end of the main pixel electrode and protruding in the first direction.

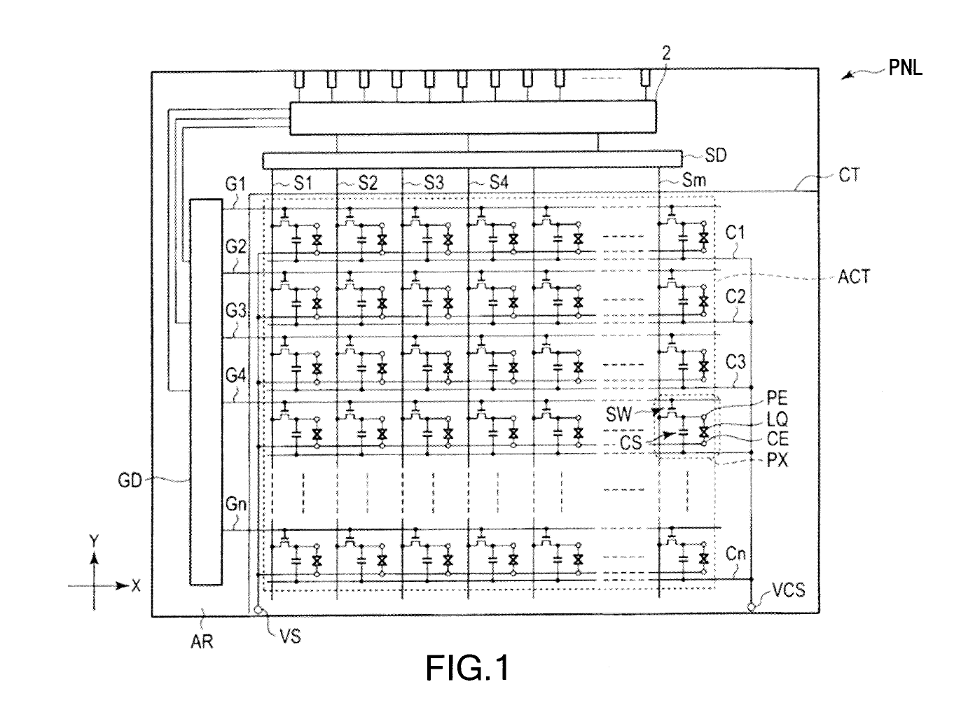

FIG. 1 is a figure schematically showing a structure and an equivalent circuit of a liquid crystal display device according to one embodiment.

The liquid crystal display panel is equipped with a liquid crystal display panel PNL of an active matrix type. The liquid crystal display panel PNL includes an array substrate AR as a first substrate, a counter substrates CT as a second substrate arranged opposing the array substrate AR, and a liquid crystal layer LQ held between the array substrate AR and the counter substrates CT. The liquid crystal display panel PNL includes an active area ACT which displays images. The active area ACT is constituted by a plurality of pixels PX arranged in the shape of a (m×n) matrix (herein, “m” and “n” are positive integers).

The liquid crystal display panel PNL is equipped with “n” gate lines G (G1-Gn), “n” storage capacitance lines C (C1-Cn), “m” source lines S (S1-Sm), etc., in the active area ACT. The gate lines G and the storage capacitance lines C respectively extend substantially linearly along a first direction X. Moreover, the gate line G and the storage capacitance line C are arranged by turns in a second direction Y that intersects the first direction X. Herein, the first direction X orthogonally crosses the second direction Y each other. However they do not necessarily extend linearly. The source lines S extend substantially linearly in the second direction Y so as to intersect the gate line G and the storage capacitance line C. In addition, the gate line G, the storage capacitance line C and source lines S do not necessarily extend linearly, and may be crooked partly.

Each gate line G is pulled out to the outside of the active area ACT, and connected to a gate driver GD. Each source line S is pulled out to the outside of the active area ACT, and connected to a source driver SD. At least a portion of the gate driver GD and the source driver SD is formed in the array substrate AR, for example, and the gate driver GD and the source driver SD are connected with a driver IC chip 2 provided in the array substrate AR and having an implemented controller.

Each pixel PX includes a switching element SW, a pixel electrode PE, a common electrode CE, etc. Storage capacitance Cs is formed, for example, between the storage capacitance line C and the pixel electrode PE. The storage capacitance line C is electrically connected with a voltage supply portion VCS to which a storage capacitance voltage is impressed.

In addition, in the liquid crystal display panel PNL according to this embodiment, while the pixel electrode PE is formed in the array substrate AR, at least a portion of the common electrode CE is formed in the counter substrate CT. The liquid crystal molecule of a liquid crystal layer LQ is switched mainly using an electric field formed between the pixel electrodes PE and the common electrodes CE. The electric field formed between the pixel electrode PE and the common electrode CE is an oblique electric field slightly oblique with respect to an X-Y plane defined by the first direction X and second direction Y, i.e., the principle surface of the substrates, or a lateral electric field substantially in parallel with the principal surfaces of the array substrate AR and the counter substrate CT.

The switching element SW is formed of an n channel type thin film transistor (TFT), for example. The switching element SW is electrically connected with the gate line G and the source line S. The switching element SW may be either a top-gate type or a bottom-gate type. Though the semiconductor layer of the switching element SW is formed of poly-silicon in this embodiment, the semiconductor layer may be formed of amorphous silicon.

The pixel electrode PE is arranged in each pixel PX and electrically connected with the switching element SW. The common electrode CE of common potential is arranged in common to the plurality of pixel electrodes PE interposing the liquid crystal layer LQ therebetween. While the pixel electrode PE and the common electrode CE are formed of transparent electric conductive materials, such as Indium Tin Oxide (ITO) and Indium Zinc Oxide (IZO), for example, they may be formed of other metal materials, such as aluminum.

The array substrate AR is equipped with an electric power supply portion VS for impressing voltage to the common electrode CE. The electric supply portion VS is formed in the outside of the active area ACT, for example. The common electrode CE is pulled out to the outside of the active area ACT, and electrically connected with the electric supply portion VS through an electric conductive component which is not illustrated.

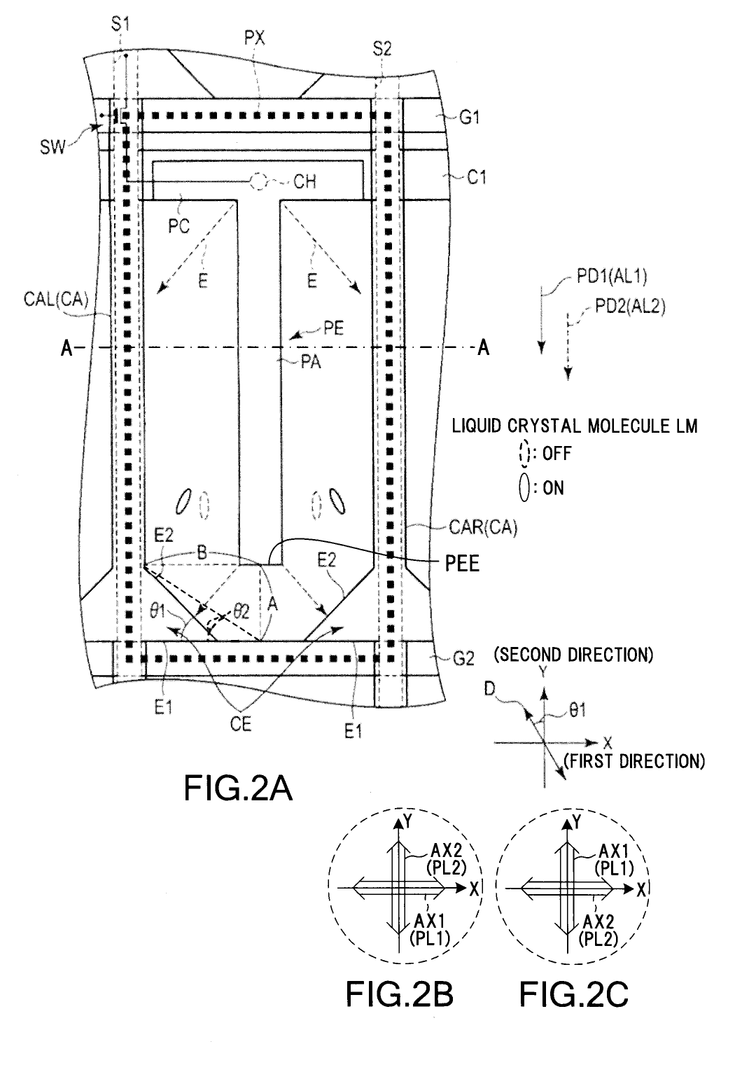

FIG. 2A is a plan view schematically showing a structure of one pixel PX when the liquid crystal display panel shown in FIG. 1 is seen from a counter substrate side according to a first embodiment. Herein, the plan view in the X-Y plane is shown.

The illustrated pixel PX is formed in a rectangular shape whose length in the first direction X is shorter than the length in the second direction Y as shown with a dashed line. In addition, according to this embodiment, the width in the first direction X of the pixel PX is approximately 40 μm. The gate line G1 and gate line G2 extend along the first direction X. The storage capacitance line C1 is arranged between the adjoining gate line G1 and gate line G2, and extend along the first direction X. The source line S1 and source line S2 extend along the second direction Y. The pixel electrode PE is arranged also between the adjoining source line S1 and source line S2. Moreover, the pixel electrode PE is arranged between the gate line G1 and gate line G2.

Moreover, in this embodiment, the source line S1 is arranged at a left-hand side end in the pixel PX. Precisely, the source line S1 is arranged striding over a boundary between the illustrated pixel and a pixel which adjoins the illustrated pixel PX on its left-hand side. The source line S2 is arranged at a right-hand side end. Precisely, the source line S2 is arranged striding over a boundary between the illustrated pixel and a pixel which adjoins the illustrated pixel PX on its right-hand side. In addition, the gate line G1 is arranged in an upper end portion, and the gate line G2 is arranged in a lower end portion of the pixel PX. Precisely, the gate line G1 is arranged striding over a boundary between the illustrated pixel PX and an adjacent pixel on the upper side. The gate line G2 is arranged striding over a boundary between the illustrated pixel PX and an adjacent pixel on the bottom side. The storage capacitance line C1 is arranged on a gate line G1 side in the pixel PX.

The switching element SW is electrically connected with the gate line G1 and the source line S1 in this embodiment. The switching element SW is formed in the circumference of an intersection between the gate line G1 and the source line S1. The drain line extends along the source line S1 and the storage capacitance line C1, and is electrically connected with the pixel electrode PE through a contact hole CH formed in a region which overlaps with the storage capacitance line C1. The switching element SW is formed in a region which overlaps with the source line S1 and the storage capacitance line C1, and hardly protrudes from the region which overlaps with the source line S1 and the storage capacitance line C1. Accordingly, reduction in an aperture area AP area contributing to a display is suppressed. In addition, the aperture area AP is a region surrounded with a first line extending in the first direction X and a second line extending in the second direction Y. That is, the aperture area AP is a region surrounded with the source lines S1, source line S2, the storage capacitance line C1, and the gate line G2 in the embodiment shown in FIG. 2A.

The pixel electrode PE is equipped with a main pixel electrode PA and a contact portion PC electrically connected mutually.

The main pixel electrode PA linearly extends from the contact portion PC to the circumference of the bottom end of the pixel PX along the second direction Y. The main pixel electrode PA is formed in a stripe shape with approximately the same width along the first direction X. The contact portion PC is located in a region which overlaps with the storage capacitance line C1, and electrically connected with the switching element SW through the contact hole CH. The width of the contact portion PC along the first direction X is formed larger than a maximum value of the width of the main pixel electrode PA in the first direction X.

The pixel electrode PE is arranged substantially in a middle portion between the source line S1 and the source line S2, i.e., the center portion of the pixel PX. The interval between the source line S1 and the pixel electrode PE along the first direction X is substantially the same as the interval between the source line S2 and the pixel electrode PE along the first direction X in each position of the pixel electrode PX along in the second direction Y.

In this embodiment, the main common electrode CA is arranged in parallel two lines along the second direction X in the right and left end portions of the pixel PX, respectively. Hereinafter, in order to distinguish the main common electrodes CA, the main common electrode CA on the left-hand side in the figure is called CAL1, and the main common electrode on the right hand side in the figure is called CAR1. The main common electrode CAL counters the source line S1, and the main common electrode CAR counters the source line S2. In the active area or out of the active area, the main common electrode CAL and the main common electrode CAR are electrically connected each other.

In the pixel PX, the main common electrode CAL is arranged in the left-hand side end portion, and the main common electrode CAR is arranged in the right-hand side end portion. Precisely, the main common electrode CAL is arranged striding over a boundary between the illustrated pixel PX and a pixel adjoining on its left-hand side, and the main common electrode CAR is arranged striding over between a boundary between the illustrated pixel PX and a pixel PX adjoining on its right-hand side.

If its attention is paid to the positional relationship between the pixel electrode PE and the main common electrode CA, the pixel electrode PE and the main common electrode CA are arranged by turns along the first direction X. The pixel electrodes PE and the main common electrode CA are arranged substantially in parallel. At this time, neither of the main common electrodes CA overlaps with the pixel electrode PE in the X-Y plane.

That is, one pixel electrode PE is located between the adjoining main common electrode CAL and main common electrode CAR. The main common electrode CAL and the main common electrode CAR are arranged on the both sides sandwiching the position right above the pixel electrode PE. That is, the pixel electrode PE is arranged between the main common electrode CAL and the main common electrode CAR. For this reason, the main common electrode CAL, the main pixel electrode PA, and the main common electrode CAR are arranged along the first direction X in this order.

The interval between the pixel electrode PE and the common electrodes CE in the first direction X is substantially the same. Namely, the interval between the main common electrode CAL and the main pixel electrode PA in the first direction X is substantially the same as the interval between the main common electrode CAR and the main pixel electrode PA.

According to this embodiment, the width in the first direction X of the main common electrode CA is formed larger in the circumference of the gate line G2. In detail, the width in the first direction X of the main common electrode CA is uniform facing the main pixel electrode extending in the second direction Y from the contact portion PC to the circumference of a lower end portion PEE of the pixel electrode PE. The width of the main common electrode CA in the first direction X becomes larger continuously from a region facing the circumference of the bottom end PEE of the main pixel electrode PA toward the gate line G2. The main common electrodes CAL and CAR are formed in line symmetry with respect to a line in parallel with the second direction Y.

That is, the main common electrode CA is equipped with a convex portion in approximately right angle shape in the circumference of the gate line G2. The convex portion includes a first end E1 extending along the gate line G2 from the end of the main common electrode CA extending in the second direction Y, and a second end E2 connecting one end portion of the first end E1 with the end of the main common electrode CA. An inside angle θ1 of the convex portion formed between the first end E1 and the second end E2 becomes larger than tan⁻¹ (A/B) (θ2). Herein, the maximum distance of the convex portion in the second direction Y is set to “A”, and the distance between the main common electrode CA and the center of the pixel PX in the first direction X is set to “B”. At this time, the distance “A” is shorter than the distance between the bottom end PEE of the main pixel electrode PA and the gate line G2 in the second direction Y. The first end E1 of the convex portion of the main pixel electrode CA is set to be shorter than “B”.

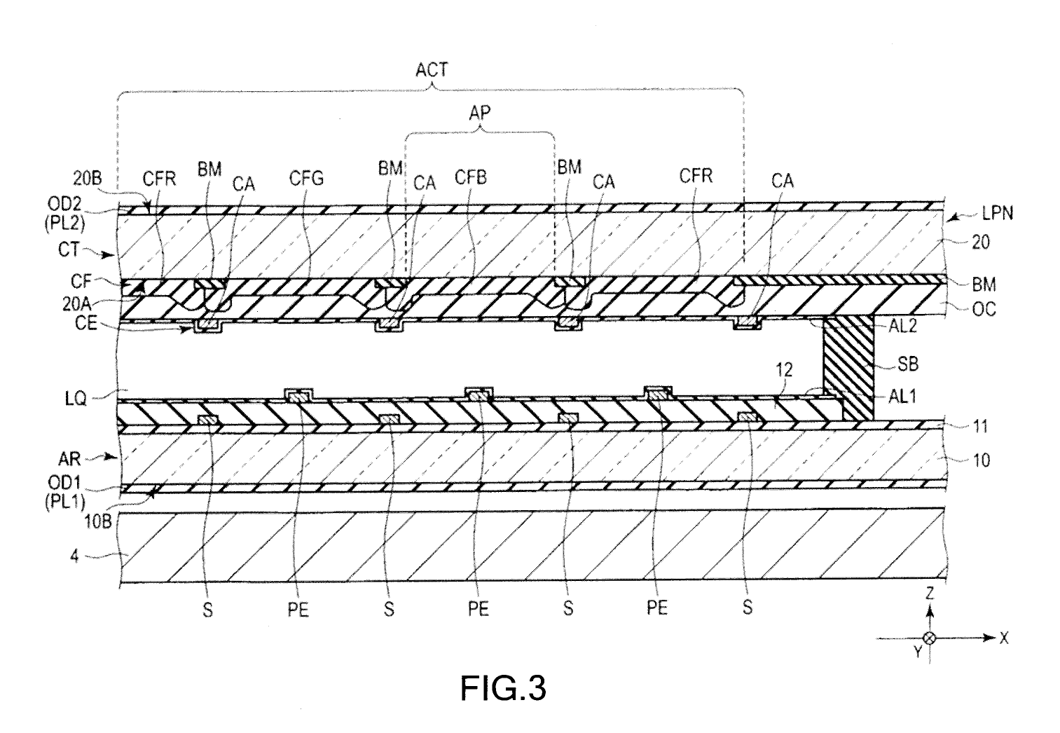

FIG. 3 is a cross-sectional view schematically showing the structure of the liquid crystal display panel PNL taken along line A-A shown in FIG. 2A. Herein, only a portion necessary for explanation is shown. In addition, a third direction Z is a direction orthogonally crossing the first direction X and the second direction Y, i.e., a normal direction of the liquid crystal panel PNL.

A backlight unit 4 is arranged on the back side of the array substrate AR forming the liquid crystal panel PNL. Various types of backlight unit 4 can be used. For example, a light emitting diode (LED) or a cold cathode fluorescent lamp (CCFL), etc., can be applied as a light source of the backlight unit 4, and the explanation about its detailed structure is omitted.

The array substrate AR is formed using a first transparent insulating substrate 10. The source line S is formed on a first interlayer insulating film 11, and covered with a second interlayer insulating film 12. In addition, the gate line and the storage capacitance line which are not illustrated are arranged between the first insulating substrate 10 and the first interlayer insulating film 11, for example. The pixel electrode PE is formed on the second interlayer insulating film 12. The pixel electrode PE is located inside of the pixel rather than the positions right above the respective adjoining source lines S.

A first alignment film AL1 is arranged on the array substrate AR facing the counter substrate CT, and extends to whole active area ACT. The first alignment film AL1 covers the pixel electrode PE, etc., and is arranged also on the second interlayer insulating film 12. The first alignment film AL1 is formed of the material which shows horizontal alignment characteristics and coated with approximately 70 nm thickness. In addition, the array substrate AR may be further equipped with a portion of the common electrodes CE.

The counter substrate CT is formed using a second transparent insulating substrate 20. The counter substrate CT includes a black matrix BM, a color filter CF, an overcoat layer OC, a common electrode CE, and a second alignment film AL2, etc.

The black matrix BM defines each pixel PX, and forms an aperture portion AP facing the pixel electrode PE. That is, the black matrix BM is arranged so that wiring portions, such as the source line, the gate line, the storage capacitance line, and the switching element, may counter with the black matrix BM. Herein, though only a portion of the black matrix BM extending along the second direction Y is shown, the black matrix BM may include a portion extending along the first direction X. The black matrix BM is formed on an internal surface 20A of the second insulating substrate 20 facing the array substrate AR.

The color filter CF is arranged corresponding to each pixel PX. That is, while the color filter CF is arranged in the aperture portion AP in the internal surface 20A of the second insulating substrate 20, a portion thereof runs on the black matrix BM. The colors of the color filters CF arranged in the adjoining pixels PX in the first direction X differ mutually. For example, the color filters CF are formed of resin materials colored by three primary colors of red, blue, and green, respectively. The red color filter CFR formed of resin material colored in red is arranged corresponding to the red pixel. The blue color filter CFB formed of resin material colored in blue is arranged corresponding to the blue pixel. The green color filter CFG formed of resin material colored in green is arranged corresponding to the green pixel. The boundary between the adjoining color filters CF is located in a position which overlaps with the black matrix BM.

The overcoat layer OC covers the color filter CF. The overcoat layer OC eases influence by concave-convex of the surface of the color filter CF.

The common electrode CE is formed on the overcoat layer OC facing the array substrate AR.

The second alignment film AL2 is arranged on the counter substrate CT facing the array substrate AR, and extends to whole active area ACT. The second alignment film AL2 covers the common electrode CE, the overcoat layer OC, etc. The second alignment film AL2 is formed of a material showing horizontal alignment characteristics, and coated with approximately 70 nm thickness.

An alignment treatment (for example, rubbing processing or light alignment processing) is performed to the first alignment film AL1 and the second alignment film AL2 to initially align the molecules of the liquid crystal layer LQ. A first alignment treatment direction PD1 in which the first alignment film AL1 initially aligns the molecules of the liquid crystal layer LQ and a second alignment treatment direction PD2 in which the second alignment film AL2 initially aligns the molecules of the liquid crystal layer LQ are in parallel, and the same directions or opposite directions each other. For example, the first alignment treatment direction PD1 and the second alignment treatment direction PD2 are substantially in parallel with the second direction Y and are the same directions each other as shown in FIG. 2A.

The array substrate AR and the counter substrate CT as mentioned-above are arranged so that the first alignment film AL1 and the second alignment film AL2 face each other. In this case, a pillar-shaped spacer is formed integrally with one of the substrates by resin material between the first alignment film AL1 on the array substrate AR and the second alignment film AL2 on the counter substrate CT. Thereby, a predetermined gap, for example, a 2-7 μm cell gap, is formed, for example. The array substrate AR and the counter substrate CT are pasted together by seal material SB outside of the active area ACT, in which the predetermined cell gap is formed. In this embodiment, the cell gap is approximately 4 μm.

The liquid crystal layer LQ is held at the cell gap formed between the array substrate AR and the counter substrate CT, and arranged between the first alignment film AL1 and the second alignment film AL2. The liquid crystal layer LQ contains the liquid crystal molecule which is constituted by positive type liquid crystal material.

A first optical element OD1 is attached on an external surface 10B of the array substrate AR, i.e., the external surface of the first insulating substrate 10 which constitutes the array substrate AR, by adhesives, etc. The first optical element OD1 is located on a side which counters with the backlight unit 4 of the liquid crystal display panel PNL, and controls the polarization state of the incident light which enters into the liquid crystal display panel PNL from the backlight unit 4. The first optical element OD1 includes a first polarization plate PL1 having a first polarizing axis (or first absorption axis) AX1.

A second optical element OD2 is attached on an external surface 20B of the counter substrate CT, i.e., the external surface of the second insulating substrate 20 which constitutes the counter substrate CT, by adhesives, etc. The second optical element OD2 is located on a display surface side of the liquid crystal display panel PNL, and controls the polarization state of emitted light from the liquid crystal display panel PNL. The second optical element OD2 includes a second polarization plate PL2 having a second polarizing axis (or second absorption axis) AX2.

The first polarizing axis AX1 of the first polarization plate PL1 and the second polarizing axis AX2 of the second polarization plate PL2 are arranged in the Crossed Nicol state in which they substantially intersects perpendicularly. At this time, one polarization plate is arranged, for example, so that its polarizing axis is arranged in the initial aliment direction, that is, in parallel with or in orthogonal with the first alignment treatment direction PD1 or the second alignment treatment direction PD2. When the initial alignment direction is in parallel with the second direction Y, the polarizing axis of one polarization plate is in parallel with the second direction Y or the first direction X.

In the embodiment shown in FIG. 2B, the first polarization plate PL1 is arranged, for example, so that the first polarizing axis AX1 is arranged orthogonally crossing the initial alignment direction (second direction Y) of the liquid crystal molecule LM, i.e., in parallel with the first direction X. The second polarization plate PL2 is arranged, for example, so that the second polarizing axis AX2 is arranged in parallel with the initial alignment direction (second direction Y) of the liquid crystal molecule LM.

As shown in FIG. 2C, the second polarization plate PL2 is arranged, for example, so that the second polarizing axis AX2 is arranged orthogonally crossing the initial alignment direction (second direction Y) of the liquid crystal molecule LM, i.e., in parallel with the first direction X. The first polarization plate PL1 is arranged, for example, so that the first polarizing axis AX1 is arranged in parallel with the initial alignment direction (second direction Y) of the liquid crystal molecule LM.

Next, the operation of the liquid crystal display panel PNL of the above-mentioned structure is explained referring to FIGS. 2A, 2B, 2C and FIG. 3.

At the time of non-electric field state (OFF), i.e., when a potential difference (i.e., electric field) is not formed between the pixel electrode PE and the common electrode CE, the liquid crystal molecules LM of the liquid crystal layer LQ are aligned so that their long axes are aligned in parallel with the first alignment treatment direction PD1 of the first alignment film AL1 and the second alignment treatment direction PD2 of the second alignment film AL2 as shown with a dashed line in the figure. In this state, the time of OFF corresponds to the initial alignment state, and the alignment direction of the liquid crystal molecule LM corresponds to the initial alignment direction.

In addition, precisely, the liquid crystal molecules LM are not exclusively aligned in parallel with the X-Y plane, but are pre-tilted in many cases. For this reason, the precise direction of the initial alignment is a direction in which an orthogonal projection of the alignment direction of the liquid crystal molecule LM at the time of OFF is carried out to the X-Y plane. Hereinafter, the explanation is made in the presumption that the liquid crystal molecules LM are aligned in parallel with the X-Y plane and rotate in a plane in parallel with the X-Y plane to simplify the explanation.

Herein, both of the first alignment treatment direction PD1 of the first alignment film AL1 and the second alignment treatment direction PD2 of the second alignment film AL2 are directions in parallel to the second direction Y each other. At the time of OFF, the long axis of the liquid crystal molecule LM is initially aligned substantially in parallel to the second direction Y as shown with a dashed line in FIG. 2A. That is, the initial alignment direction of the liquid crystal molecule LM is in parallel to the second direction Y, i.e., makes an angle of 0° with respect to the second direction Y.

In the cross-section of the liquid crystal layer LQ, when the first alignment direction PD1 and the second alignment direction PD2 are in parallel and the same directions each other, the liquid crystal molecule LM is aligned substantially in the horizontal direction (pre-tilt angle is substantially zero) in the circumference of the intermediate region of the liquid crystal layer LQ. In the circumference of the first alignment film AL1 and the second alignment film AL2, the liquid crystal molecule LM is aligned with a pre-tilt angle which becomes in symmetry with respect to the intermediate region. That is, the liquid crystal molecule LM is aligned in a splay alignment state.

Herein, the liquid crystal molecule LM in the circumference of the first alignment film AL1 is initially aligned in the first alignment treatment direction PD 1 by performing the alignment processing in the first alignment treatment direction PD1, and the liquid crystal molecule LM in the circumference of the second alignment film AL2 is initially aligned in the second alignment treatment direction PD2 by performing the alignment processing in the second alignment treatment direction PD2. When the first alignment treatment direction PD1 and the second alignment treatment direction PD2 are in parallel and the same directions each other, the liquid crystal molecule LM becomes the splay alignment state, that is, aligns substantially in the horizontal direction in the intermediate region of the liquid crystal layer LQ. The liquid crystal molecule LM aligns in symmetry with respect to the intermediate region in the circumference of the first alignment film AL1 on the array substrate AR and the second alignment film AL2 on the counter substrate CT. In the splay alignment state of the liquid crystal molecule LM, the display is optically compensated even in an inclining direction from the normal direction (third direction “z”) of the substrate by the molecules in the circumference of the first alignment film AL1 and the second alignment film AL2. Therefore, when the first alignment film AL1 and the second alignment film AL2 are in parallel and the same directions mutually, optical leak is hardly generated in a black display. Accordingly, high contrast ratio can be obtained, and it becomes possible to improve display grace.

In addition, when the first alignment treatment direction PD1 and the second alignment treatment direction PD2 are in parallel and opposite directions each other, in the cross section of the liquid crystal layer LQ, the liquid crystal molecule LM aligns with a uniform pre-tilt angle in the intermediate region, and in the circumference of the first alignment film AL1 and the second alignment film AL2 of the liquid crystal layer LQ (homogeneous alignment).

The backlight from the backlight unit 4 penetrates the first polarization plate PL1, and enters into the liquid crystal display panel PNL. The polarization state of the incident light changes in accordance with the alignment state of the liquid crystal molecule LM when the incident light passes the liquid crystal layer LQ. The incident light which penetrates the liquid crystal display panel PNL is absorbed by the second polarization plate PL2 (black display).

On the other hand, in case potential difference (or electric field) is formed between the pixel electrode PE and the common electrode CE, i.e., at the time of ON, the lateral electric field (or oblique electric field) is formed substantially in parallel with the substrates between the pixel electrode PE and the common electrode CE. The liquid crystal molecules LM are affected by the electric field between the pixel electrode PE and the common electrode CE, and the long axes thereof rotate in parallel with the X-Y plane as shown with a solid line in the figure.

In the embodiment shown in FIGS. 2A, 2B and 2C in the region between the pixel electrode PE and the main common electrode CAL, the liquid crystal molecule LM mainly rotates clockwise to the second direction Y, and aligns so that it may turn to the lower left in the figure. On the other hand, in the region between the pixel electrode PE and the main common electrode CAR, the liquid crystal molecule LM mainly rotates counterclockwise to the second direction Y, and aligns so that it may turn to the lower light in the figure.

Thus, in each pixel PX, in case electric field is formed between the pixel electrode PE and the common electrode CE, the alignment direction of the liquid crystal molecule LM is divided into two or more directions by the position which overlaps with the pixel electrode PE, and domains are formed in each alignment direction. That is, two or more domains are formed in one pixel PX.

At the time ON as above, a portion of the backlight from the backlight unit 4 penetrates the first polarizing plate PL1, and enters into the liquid crystal display panel PNL. The polarization state of the incident light changes in accordance with the alignment state of the liquid crystal molecule LM when the incident light passes the liquid crystal layer LQ. At the time ON, a portion of the incident light which penetrates the liquid crystal display panel PNL passes the second polarization plate PL2 (white display).

In the OFF state, the liquid crystal molecule LM is initially aligned substantially in parallel with the second direction Y. In the ON state in which potential difference is formed between the pixel electrode PE and the common electrode CE, when director or long axis direction of the liquid crystal molecule LM is shifted substantially by 45° in the X-Y plane with respect to the first polarizing axis AX1 of the first polarization plate PL1 and the second polarizing axis AX2 of the second polarization plate PL2, an optical modulation rate of the liquid crystal molecule becomes the highest. That is, the transmissivity in the aperture portion becomes the maximum.

In this embodiment, when the liquid crystal molecule changes into the ON state, the director of the liquid crystal molecule LM between the main common electrode CAL and the pixel electrode PE becomes substantially in parallel with a direction of 45°-225° in the X-Y plane. The director of the liquid crystal molecule LM between the main common electrode CAR and the pixel electrode PE becomes substantially in parallel with a direction of 135°-315° in the X-Y plane, and a peak transmissivity is obtained. At this time, if the transmissivity distribution per one pixel is focused, while the transmissivity becomes substantially zero on the pixel electrode PE and the common electrode CE, high transmissivity is obtained in the whole electrode gap between the pixel electrode PE and the common electrode CE.

The main common electrode CAL located right above the source line S1 and the main common electrode CAR located right above and the source line S2 counter the black matrix BM, respectively. In addition, the main common electrode CAL and the main common electrode CAR have a width equal to or smaller than the width of the black matrix in the first direction X, and do not extend to the pixel electrode PE side beyond the position overlapping with the black matrix BM.

According to this embodiment, it becomes possible to suppress the decrease in transmissivity. Thereby, it becomes possible to control degradation of display grace.

Moreover, according to this embodiment, it becomes possible to obtain high transmissivity in the electrode gap between the pixel electrode PE and the common electrode CE. Accordingly, it becomes possible to obtain sufficient transmissivity in each pixel by expanding the inter-electrode distance between the pixel electrode PE and the main common electrodes CAL and CAR. Further, in product specifications in which pixel pitches differ in the displays each other, a transmissive distribution peak can be used by changing the inter-electrode distance, i.e., by changing the location of the main common electrode CA with respect to the pixel electrode PE arranged substantially in the center of the pixel PX. That is, in the display mode according to this embodiment, it becomes possible to supply the display panel having various pixel pitches by setting up the inter-electrode distance without necessarily using microscopic processing corresponding to the product specifications from low resolution with a comparatively large pixel pitch to high resolution with a comparatively small pixel pitch. Therefore, it becomes possible to realize the demand for high transmissivity and high resolution easily.

Moreover, according to this embodiment, the transmissivity fully falls in a region which overlaps with the black matrix BM. This is because the leakage of electric field from the common electrode CE does not occur outside of the pixel, and undesired lateral electric field is not produced between the adjoining pixels sandwiching the black matrix BM. That is, it is because the liquid crystal molecule which overlaps with the black matrix BM maintains the initial alignment state like at the time OFF (or the time of the black display). Accordingly, even if it is a case where the colors of the color filter differ between the adjoining pixels, it becomes possible to control the generation of mixed colors and also to control the fall of color reproducibility and the contrast ratio.

Moreover, when an assembling shift occurs between the array substrate AR and the counter substrate CT, a difference may arise in horizontal distances in the first direction X between the respective common electrodes CE of the both sides of the pixel and the pixel electrode PE. However, since the assembling shift is generated in common to all the pixels PX, there is no difference in the electric field distribution between the pixels PX, and the influence to the display of the image is very small. Even if the assembling shift arises between the array substrate AR and the counter substrate CT, it becomes possible to control the undesirable electric field leakage to the adjoining pixels. For this reason, even if it is in a case where the colors of the color filter differ between the adjoining pixels, it becomes possible to control the generation of the mixed colors and also to suppress the falls of color reproducibility nature and the contrast ratio.

According to this embodiment, the main common electrodes CA counter with the source lines S, respectively. When the main common electrode CAL and the main common electrode CAR are especially arranged on the source line S1 and the source line S2, respectively, the aperture portion AP which contributes to the display can be expanded as compared with the case where the main common electrode CAL and the main common electrode CAR are arranged on the pixel electrode PE side rather than above the source line S1 and the source line S2, and it becomes possible to improve the transmissivity of the pixel PX.

Moreover, it becomes possible to expand the distances between the pixel electrode PE and the main common electrode CAL, and between the pixel electrode PE and the main common electrode CAR by arranging each of the main common electrode CAL and the main common electrode CAR above the source line S1 and the source line S2, respectively, and also becomes possible to form the lateral electric field closer to the horizontal direction. Therefore, it becomes possible to maintain the feature of the wide view angle which is a merit of the IPS mode.

Moreover, according to this embodiment, it becomes possible to form two or more domains in one pixel. For this reason, the viewing angle can be optically compensated in two or more directions, and the wide viewing angle characteristics is attained.

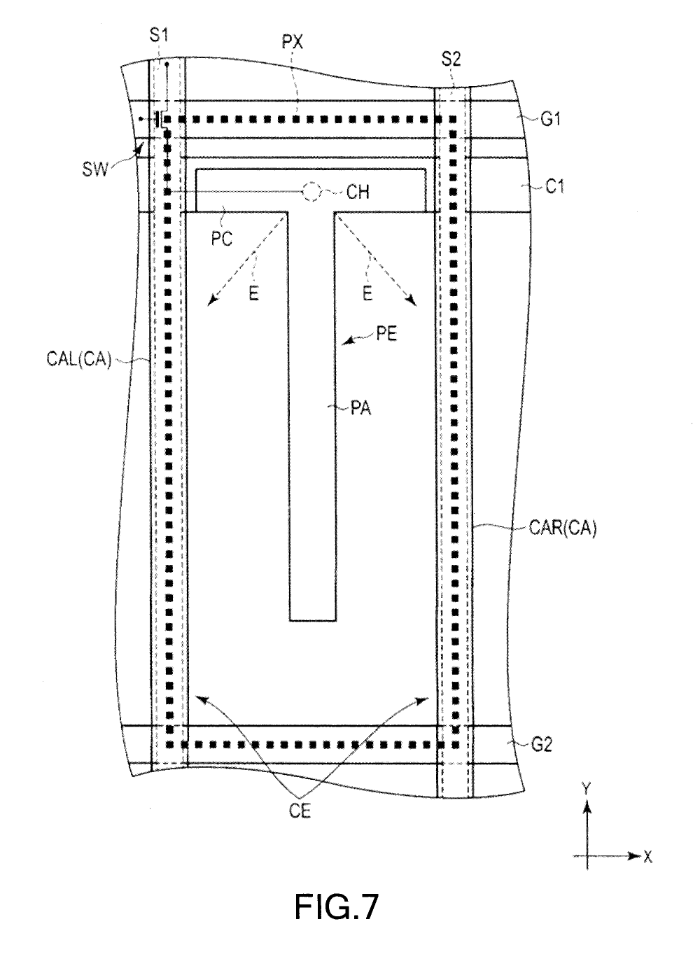

FIG. 7 is a plan view schematically showing a structure of one pixel according to a reference example in which the width of the main common electrode CA in the first direction X is made uniform, and the main common electrode is formed in a stripe shape extending in the second direction Y. In this reference example, the structures other than the main common electrode CA are the same as those of the first embodiment.

If the circumference of the contact portion PC and a region away from the contact portion PC are compared, electric field generated between the pixel electrode PE and the common electrode CE is strong in the circumference of the contact portion PC. On the other hand, the electric field generated between the pixel electrode PE and the common electrode CE becomes weaker with the distance from the contact portion PC. It is thought that although the electric field E arises in the circumference of the contact portion PC from a connecting position of the contact portion PC with the main pixel electrode PA toward the main common electrode CA in a slanting down direction, the influence by the electric field E becomes weak with the distance from the contact portion PC. In addition, the direction of the electric field E shown in FIG. 7 is a sum of electric field component parallel to the first direction X and electric field component parallel to the second direction Y, and an electric field component parallel to the third direction Z is not taken into consideration.

Therefore, when the main pixel electrode PA in the stripe shape linearly extending is formed as shown in FIG. 7, the electric field which arises between the main pixel electrode PA and the main common electrode CA becomes weak with the distance from the contact portion PC along the second direction Y, and when pressure is applied to the display panel, it may be difficult that the alignment state of the liquid crystal molecule LM returns to a predetermined state. Thus, display grace falls because the pressed mark is left.

On the other hand, in this embodiment, the main common electrode CA includes a convex portion projected along the gate line G2. In the embodiment shown in FIG. 2A, the convex portion in the shape of an approximately right triangle includes a first end E1 extending from the end of the main common electrode CA along the gate line G2 and a second end E2 connected between one edge portion of the first end E1 and the end of the main common electrode CA extending in the second direction Y. By providing the convex portion in the main common electrode CA, a slanting down electric field E arises between the main pixel electrode PA and the second end E2 of the convex portion in the main common electrode CA. For this reason, it is suppressed that the electric field formed between the main pixel electrode PA and the main common electrode CA becomes weak in the region apart from the contact portion PC in the first embodiment. Thereby, it is suppressed that the pressed mark is left.

Moreover, it is necessary that the convex portion in the pixel be arranged in a position away from the contact portion PC in order to suppress for the oblique electric field component to become weaker. Therefore, the distance of the main common electrode CA along the second direction between a location facing the crossing portion of the main pixel electrode PA and the contact portion PC and the crossing portion of the gate line and the source line portion in which the concave portion is formed is set larger than half of the length along the long end of the pixel. That is, the convex portion is arranged in the circumference of the intersection portion between the gate line G2 and the source lines S1 and S2 rather than in the circumference of the intersection portion between the gate line G1 and the source lines S1 and S2.

When response time (time for changing from OFF state to ON state) of the liquid crystal in the pixel PX shown in FIG. 7 is set to 100, for example, by providing the convex portion in one PX, the response time of the liquid crystal became 88 in the pixel PX shown in FIG. 2A. That is, according to this first embodiment, it becomes possible to supply a crystal display device with excellent display grace.

In addition, in the above-mentioned embodiment, the case where the alignment direction of the liquid crystal molecule LM is in parallel to the second direction Y is explained. However, the initial alignment direction of the liquid crystal molecule LM may be the oblique direction D which obliquely crosses the second direction Y as shown in FIG. 2A. Herein, the angle θ1 formed by the initial alignment direction D and the second direction Y is larger 0° and smaller than 45°. In addition, it is extremely effective to set the angle θ1 in the range of 5° to 30°, more preferably less than 20° in a viewpoint of the alignment control of the liquid crystal molecule LM. That is, it is preferable that the initial alignment direction of the liquid crystal molecule LM is set to a direction substantially in parallel with the direction in the range of 0° to 20° with respect to the second direction Y.

Moreover, although the above-mentioned embodiment explains the case where the liquid crystal layer LQ has positive dielectric constant anisotropy, the liquid crystal layer LQ may have negative dielectric constant anisotropy. That is, n type liquid crystal material may be used. Although detailed explanation is omitted, when the negative type liquid crystal material is used, it is preferable that the above-mentioned angle θ1 is made in the range of 45° to 90° and more preferably not less than 70° because the dielectric constant anisotropy becomes a contrast relation between the positive type and the negative type.

Furthermore, even at the time of ON, since the lateral electric field is hardly formed (or sufficient electric field to drive the liquid crystal molecule LM is not formed) on the pixel electrode PE or the common electrode CE, the liquid crystal molecule LM hardly moves from the initial alignment direction like at the time of OFF. For this reason, even if the pixel electrode PE and the common electrode CE are formed of the transparent electric conductive materials such as ITO in these regions, the backlight hardly penetrates, and also hardly contributes to the display at the time of ON. Therefore, the pixel electrode PE and the common electrode CE do not necessarily need to be formed of the transparent electric conductive material, and may be formed using non-transparent electric conductive materials, such as aluminum (Al), silver (Ag), and copper (Cu).

In this embodiment, the structure of the pixel PX is not limited to the embodiment shown in FIG. 2A.

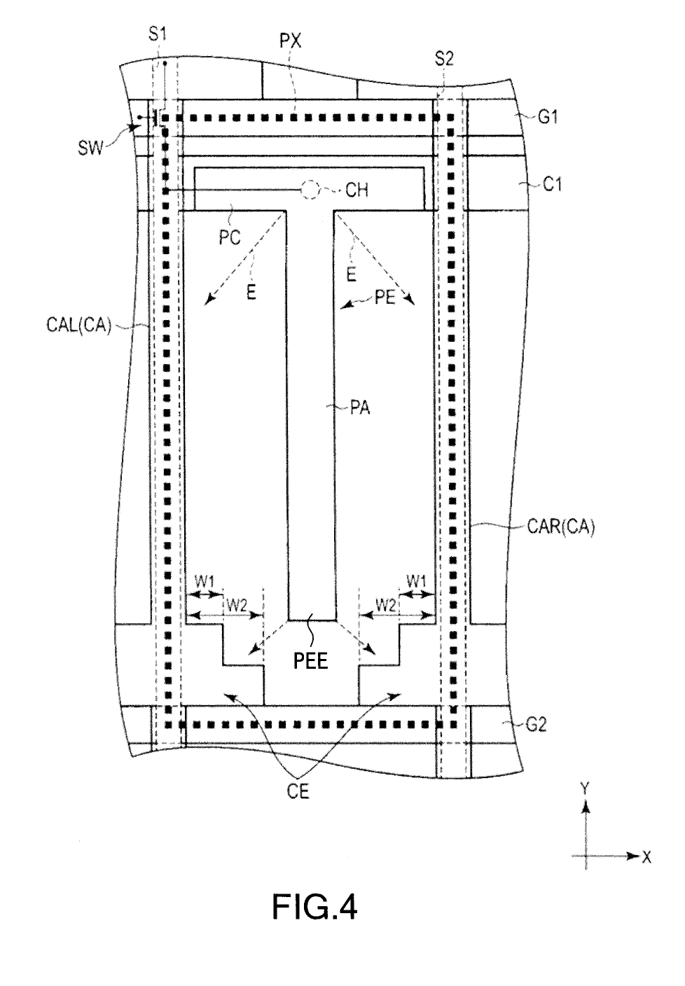

FIG. 4 is a plan view schematically showing a structure of one pixel when the liquid crystal display panel PNL shown in FIG. 1 is seen from the counter substrate side according to a second embodiment.

In this embodiment, the form of the convex portion of the main common electrode CA is different from that shown in FIG. 2A. That is, the width in the first direction X of the main common electrode CA becomes larger in a step-like shape as the main common electrode closes to the gate line G2.

The width of the main common electrode CA in the first direction X is uniform facing the main pixel electrode PE from the circumference of the contact portion PC to the bottom end portion PEE of the main pixel electrode PA along the second direction Y, and becomes larger gradually in a step-like shape as the main common electrode closes to the gate line G2. The main common electrodes CAL and CAR are formed in symmetry with respect to a line substantially parallel to the second direction Y.

That is, the convex portion is equipped with two steps so that the width in the first direction X of the main pixel electrode CA may become larger as the main pixel electrode CA closes to the gate line G2 between the bottom end portion PEE of the main pixel electrode PA and the gate line G2 in the second direction Y. That is, the convex portion has two ends extending in the first direction X and the second direction Y, respectively.

In this embodiment, the convex portion of the main common electrode CA has a first region whose width in the first direction X is W1, and a second region whose width in the first direction X is W2 (W2>W1). The second region is arranged closer to the gate line G2 than the first region G1 is arranged. In addition, the maximum width of the convex portion of the main common electrode CA in the first direction X is smaller than the distance B shown in FIG. 2A.

In the embodiment shown in FIG. 4, two steps are provided in the end of the main common electrode CA along the second direction Y between the bottom end portion PEE of the main pixel electrode PA and the gate line G2. By providing the steps, the end extending in the first direction X and the end extending in the second direction Y are connected each other, and oblique electric field E is uniformly generated from the main pixel electrode PA toward the main common electrode CA like between the circumference of the contact portion and the main common electrode CA. Therefore, it is suppressed like the first embodiment shown in FIG. 2A that the electric field which arises between the main pixel electrode PA and the main common electrode CA becomes weak in the region apart from the contact portion PC, and that the pressed mark is left. According to the second embodiment, the same effect as the first embodiment can be attained, and it becomes possible to supply a liquid crystal display having excellent display grace.

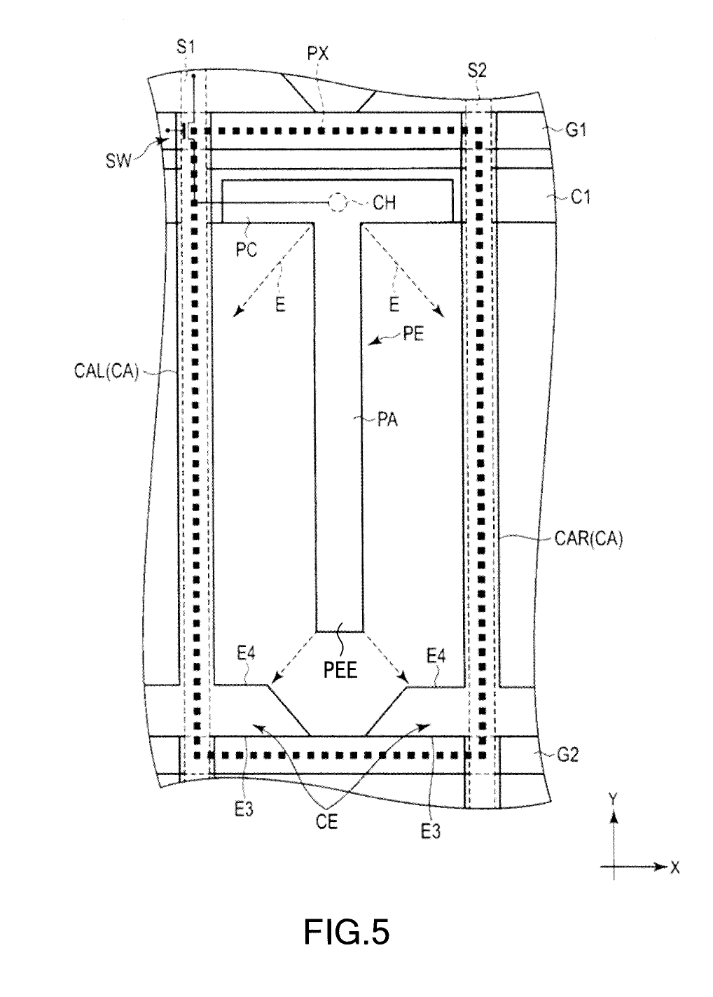

FIG. 5 is a plan view schematically showing a structure of one pixel when the liquid crystal display panel shown in FIG. 1 is seen from the counter substrate side according to a third embodiment.

In this embodiment, the form of the convex portion of the main common electrode CA is different from that shown in FIG. 2A.

The main common electrode CA is equipped with an approximately trapezoid convex portion. The trapezoid convex portion has a third end E3 extending in the first direction X along the gate line G2 from the end of the main common electrode CA, and a fourth end E4 extending substantially in parallel to the third end E3. The third end E3 is longer than the fourth end E4, and is arranged more apart from the contact portion PC rather than the fourth end E4 is arranged. The maximum width in the first direction X of the convex portion of the main common electrode CA is smaller than the distance B shown in FIG. 2A. The width of the convex portion of the main common electrode CA in the second direction Y is smaller than the distance between the end portion PEE of the main pixel electrode PA extending in the second direction Y and the gate line G2.

According to the third embodiment as shown in FIG. 5, the oblique electric field E is uniformly generated from the main pixel electrode PA toward the main common electrode CA like the first embodiment shown in FIG. 2A. Therefore, it is suppressed like the first embodiment shown in FIG. 2A that the electric field which arises between the main pixel electrode PA and the main common electrode CA becomes weak in the region apart from the contact portion PC, and that the pressed mark is left. According to the third embodiment shown in FIG. 5, the same effect as the first embodiment can be attained, and it becomes possible to supply a liquid crystal display having excellent display grace.

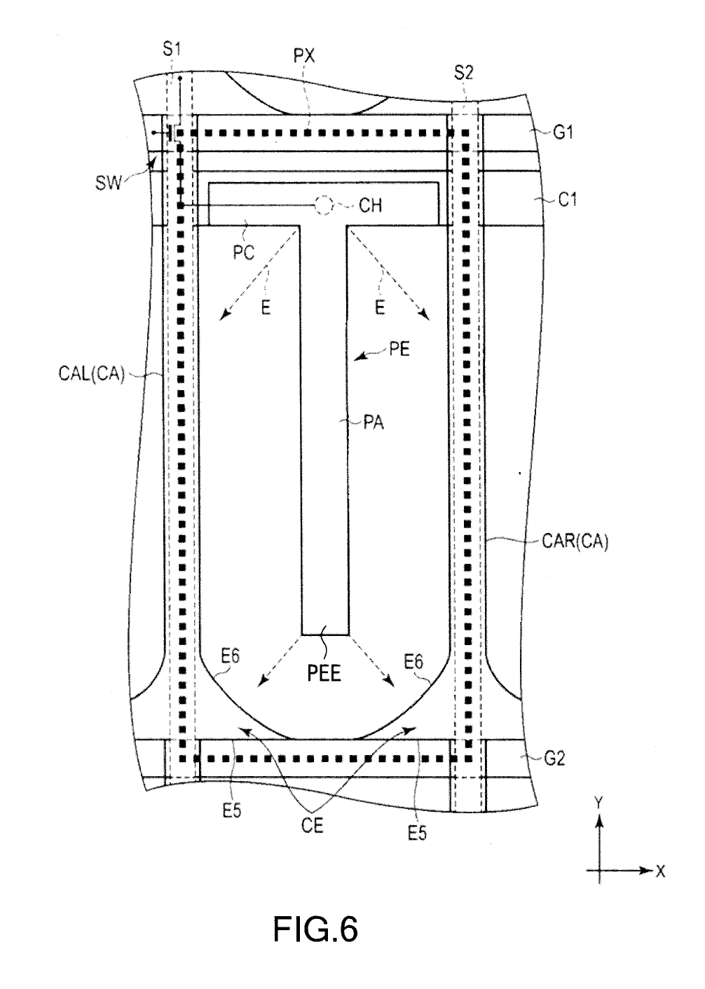

FIG. 6 is a plan view schematically showing a structure of one pixel when the liquid crystal display panel shown in FIG. 1 is seen from the counter substrate side according to a fourth embodiment.

In this embodiment, the form of the convex portion of the main common electrode CA is different from that shown in FIG. 2A.

The width of the main common electrode CA in the first direction X is formed larger in the circumference of the gate line G2. That is, the width of the main common electrode CA in the circumference of the gate line G2 becomes larger continuously in a curved shape between the bottom end portion PEE of the main pixel electrode PA and the gate line G2 in the second direction Y. The main common electrodes CAL and CAR are formed in symmetry with a line substantially in parallel to the second direction Y.

The convex portion is equipped with a fifth end E5 extending in the first direction X along the gate line G2 from the end of the main common electrode CA, and a sixth end E6 formed in a curved shape and connected between one edge portion of the fifth end E5 and the end of the main common electrode CA. The sixth end E6 is formed in the curved shape depressed toward the gate line G2.

The maximum width of the convex portion of the main common electrode CA in the first direction X is smaller than the distance B shown in FIG. 2A. The width of the convex portion of the main common electrode CA in the second direction Y is smaller than the distance between the bottom end portion PEE of the main pixel electrode PA and the gate line G2.

According to the fourth embodiment as shown in FIG. 6, the oblique electric field E is uniformly generated from the main pixel electrode PA toward the main common electrode CA like the first embodiment shown in FIG. 2A. Therefore, it is suppressed like the embodiment shown in FIG. 2A that the electric field which arises between the main pixel electrode PA and the main common electrode CA becomes weak in the region apart from the contact portion PC, and that the pressed mark is left. According to the fourth embodiment shown in FIG. 6, the same effect as the first embodiment can be attained, and it becomes possible to supply a liquid crystal display having excellent display grace.

In addition, in the embodiments, the common electrode CE may be equipped with a sub-common electrode arranged above the gate line G and extending in the first direction X other than the main common electrode CA. That is, the sub-common electrodes are arranged with an interval therebetween substantially in parallel in the second direction Y, and extending in the first direction X, respectively. The pixel electrode PE is arranged between the adjacent sub-common electrodes.

If its attention is paid to the spatial relationship between the pixel electrode PE and the common electrode CE, the main pixel electrode PA and the main common electrode CA are arranged by turns along the first direction X, and the contact portion PC and the sub-common electrode are arranged by turns along the second direction Y. Moreover, one contact portion PC is arranged between the adjoining sub-common electrodes, and the sub-common electrode, the contact portion PC, and the sub-common electrode are arranged in this order along the second direction Y.

Also in this structure, the liquid crystal molecule LM initially aligned in the second direction Y at the time of OFF forms a plurality of domains in each pixel at the time of ON in which the electric field is formed between the pixel electrode PE and the common electrode CE. Therefore, it becomes possible to expand viewing angle.

In addition, the common electrode CE may be equipped with a second main common electrode provided on the array substrate AR and facing the main common electrode CA (or source line S) arranged on the counter substrate CT. The second main common electrode extends in parallel to the main common electrode CA and is set to the same potential as the main common electrode CA. By providing the second main common electrode, it is possible to shield undesired electric field from the source line S. The convex portion of the main common electrode CA in the above-mentioned embodiments may be provided only in the second main common electrode, and also may be provided in both of the main common electrode CA and the second main common electrode. In any cases, the same effect as above-mentioned embodiments is acquired.

Furthermore, the common electrode CE may be equipped with a second sub-common electrode arranged on the array substrate AR and facing the gate line G and the storage capacitance line C in addition to the main common electrode CA arranged on the counter substrate CT. The second sub-common electrode extends in a crossing direction with the main common electrode CA, and is set to the same potential as the main common electrode CA. By providing the second sub-common electrode, it is possible to shield undesired electric field from the gate line G and the storage capacitance line C. According to the structure in which the second main common electrode and the second sub-common electrode, it becomes possible to more suppress the fall of the display grace.

As explained above, according to the embodiments, it becomes possible to supply a liquid crystal display device which can control degradation of display grace.

In the embodiments shown in FIG. 4 and FIG. 5, although the convex portion of the main common electrode CA is surrounded by straight line ends, the straight line ends do not need to be connected at right angle or blunt angle, and may be connected in a rounded shape at corners.

In the embodiments, though the contact portion is arranged adjacent to the gate line G1, it is possible to arrange the contact portion substantially in the center of the pixel between the gate line G1 and gate line G2.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A liquid crystal display device, comprising:
a first substrate including a pixel electrode including a contact portion and a main pixel electrode extending in a second direction from the contact portion so as to form one end opposite to the contact portion;
a second substrate including a pair of main common electrodes arranged on both sides sandwiching the main pixel electrode and respectively having an end extending in the second direction; and
a liquid crystal layer held between the first substrate and the second substrate, wherein
the width of the contact portion in a first direction orthogonally crossing the second direction is larger than the width of the main pixel electrode in the first direction, and
the main common electrode includes a convex portion provided in a position more apart from the contact portion than the one end of the main pixel electrode and protruding in the first direction.

2. A liquid crystal display device, comprising:
a first substrate including a pixel electrode including a contact portion and a main pixel electrode extending in a second direction from the contact portion so as to form one end opposite to the contact portion;
a second substrate including a pair of first main common electrodes arranged on both sides sandwiching the main pixel electrode and respectively having an end extending in the second direction; and
a liquid crystal layer held between the first substrate and the second substrate, wherein
the first substrate includes a pair of second main common electrodes facing the first main common electrodes,
the width of the contact portion in a first direction orthogonally crossing the second direction is larger than the width of the main pixel electrode in the first direction, and
the second main common electrode includes a convex portion provided in a position more apart from the contact portion than the one end of the main pixel electrode and protruding in the first direction.

3. The liquid crystal display device according to claim 1, wherein the width of the concave portion in the first direction is set to become continuously larger as the concave portion is apart from the contact portion.

4. The liquid crystal display device according to claim 1, wherein the width of the concave portion in the first direction is set to become larger in a step-like shape as the concave portion is apart from the contact portion.

5. The liquid crystal display device according to claim 1, wherein the concave portion includes a first end having one end portion and extending in the first direction, and a second end connected with the one end portion of the first end and the end of the main common electrode extending in the second direction.

6. The liquid crystal display device according to claim 5, wherein the second end is formed in a line shape.

7. The liquid crystal display device according to claim 5, wherein the second end is formed in a curved shape.

8. The liquid crystal display device according to claim 1, wherein the concave portion is formed by being surrounded with one end extending in the first direction and another end extending in the second direction.

9. The liquid crystal display device according to claim 1, wherein
the concave portion includes a third end and a fourth end extending in the first direction, and
the third end is longer than the fourth end, and located more apart from the contact portion than the fourth end is apart from the contact portion.

10. The liquid crystal display device according to claim 1, wherein the main pixel electrode is provided in a pixel in which the length along the first direction is shorter than the length along the second direction.

11. A liquid crystal display device, comprising:
a first substrate including;
first and second gate lines extending in a first direction,
first and second source lines extending in a second direction orthogonally crossing the first direction, and
a pixel electrode including a contact portion and a main pixel electrode electrically coupled with the contact portion and extending in the second direction from the contact portion so as to form one end opposite to the contact portion;
a second substrate including a pair of main common electrodes arranged on both sides sandwiching the main pixel electrode and respectively having an end extending in the second direction; and
a liquid crystal layer held between the first substrate and the second substrate, wherein
the width of the contact portion in the first direction is larger than the width of the main pixel electrode in the first direction,
the main common electrode includes a convex portion provided adjacent to the second gate line in a region between the one end of the main pixel electrode and the second gate line, and
the convex portion protrudes from the end of the main common electrode in the first direction.

12. A liquid crystal display device, comprising:
a first substrate including;
first and second gate lines extending in a first direction,
first and second source lines extending in a second direction orthogonally crossing the first direction, and
a pixel electrode including a contact portion and a main pixel electrode electrically coupled with the contact portion and extending in the second direction from the contact portion so as to form one end opposite to the contact portion;
a second substrate including a pair of first main common electrodes arranged on both sides sandwiching the main pixel electrode and extending in the second direction; and
a liquid crystal layer held between the first substrate and the second substrate, wherein
the first substrate includes a pair of second main common electrodes facing the first main common electrodes,
the width of the contact portion in the first direction is larger than the width of the main pixel electrode in the first direction,
the second main common electrode includes a convex portion provided adjacent to the second gate line in a region between the one end of the main pixel electrode and the second gate line, and
the second main common electrode includes an end extending along the second direction, and the convex portion protrudes from the end of the second main common electrode in the first direction.

13. The liquid crystal display device according to claim 11, wherein the contact portion is arranged adjacent to the first gate line.

14. The liquid crystal display device according to claim 11, wherein the width of the concave portion in the first direction is set to become continuously larger as the concave portion closes to the second gate line.

15. The liquid crystal display device according to claim 11, wherein the width of the concave portion in the first direction is set to become larger in a step-like shape as the concave portion closes to the second gate line.

16. The liquid crystal display device according to claim 11, wherein the concave portion includes a first end having one end portion extending in the first direction and a second end connected with the one end portion of the first end and the end of the second main common electrode.

17. The liquid crystal display device according to claim 16, wherein the second end is formed in a line shape.

18. The liquid crystal display device according to claim 16, wherein the second end is formed in a curved shape.

19. The liquid crystal display device according to claim 11, wherein the concave portion is formed by being surrounded with one end extending in the first direction and another end extending in the second direction.

20. The liquid crystal display device according to claim 11, wherein
the concave portion includes a third end and a fourth end extending in the first direction in parallel each other, and
the third end is longer than the fourth end, and located adjacent to the second gate line.
